(19) United States
(12) Patent Application Publication
(10) Pub. No.: US 2018/0236848 A1
(43) Pub. Date: Aug. 23, 2018

(54) CONVERTIBLE TOP INCORPORATING A HEAT GENERATING ELEMENT

(71) Applicant: FORD GLOBAL TECHNOLOGIES, LLC, Dearborn, MI (US)

(72) Inventors: David Paul Kaminski, Rochester Hills, MI (US); Dragos Maciuca, Mountain View, CA (US); Michael James Whitens, Novi, MI (US)

(21) Appl. No.: 15/584,434

(22) Filed: May 2, 2017

Related U.S. Application Data
(63) Continuation-in-part of application No. 15/440,309, filed on Feb. 23, 2017.

(51) Int. Cl. B60H 1/22; B60S 1/02; B60J 7/16; H05B 3/14

(52) U.S. Cl. CPC B60H 1/2225; B60S 1/026; B60S 1/66; H05B 3/145; B60J 7/1664

(57) ABSTRACT

A convertible top includes an outer layer, a liner and a heating element between the outer layer and the liner. The heating element may comprise a carbon nanotube heating element. A controller is configured to activate the heating element in response to a wireless activation signal received from a remote communication device.

This application is a continuation in part of U.S. patent application Ser. No. 15/440,309 filed on 23 Feb. 2017.

### TECHNICAL FIELD

This document relates generally to the motor vehicle equipment field and, more particularly, to a convertible top incorporating a heat generating element to heat the occupants and passenger compartment of a motor vehicle.

### BACKGROUND

During winter in many locations around the world, the temperature may fall to uncomfortably low levels. The windshield and ground near the doors of the motor vehicle may be covered in ice and snow. An individual approaching or standing near the motor vehicle might slip due to the winter weather conditions.

This document relates to a new and improved heat generating system for a motor vehicle that may be utilized for a number of purposes including, for example, heating the windshield of the motor vehicle, heating the passenger compartment or even heating the ground of the motor vehicle adjacent the motor vehicle doors in order to melt ice and snow in order to improve the footing adjacent the motor vehicle when opening the door of the motor vehicle.

### SUMMARY

In accordance with the purposes and benefits described herein, a convertible top is provided. That convertible top comprises an outer layer, a liner and a heating element between the outer layer and the liner. The heating element may comprise a carbon nanotube heating element.

The convertible top may further include a controller configured to activate the heating element in response to a wireless activation signal received from a remote communication device. The convertible top may further include an insulation layer between the outer layer and the heating element. The convertible top may further include a reflector between the outer layer and the heating element. The convertible top may further include both an insulation layer and a reflector between the outer layer and the heating element. The reflector may be adjacent the heating element and the insulation layer may be between the reflector and the outer layer.

The convertible top may further include a first rib and a second rib provided between the outer layer and the liner. The heating element may be positioned between the first rib and the second rib within the outer layer and the liner. The convertible top may also include a window.

In accordance with an additional aspect, a convertible top comprises an outer layer, a liner, a first heating element between the outer layer and the liner and a second heating element between the outer layer and the liner. The convertible top may further include a controller configured to provide independent control of the first heating element and the second heating element. That controller may be further configured to activate the first heating element, the second heating element or both the first heating element and the second heating element in response to an activation signal received from a remote communication device.

The first heating element and the second heating element may be carbon nanotube heating elements. The convertible top may further include an insulation layer between (a) the outer layer and (b) the first heating element and the second heating element. The convertible top may further include a reflector between (a) the outer layer and (b) the first heating element and the second heating element.

The convertible top may further include an insulation layer and a reflector between (a) the outer layer and (b) the first heating element and the second heating element. In such an embodiment, the reflector may be provided adjacent (a) the first heating element and the second heating element and (b) the insulation layer may be provided between the reflector and the outer layer. The convertible top may further include a first rib and a second rib between the outer layer and the liner. The first heating element and the second heating element may be positioned between the first rib and the second rib. The convertible top may also include a window. Further, the reflector may include a first reflector element overlying the first heating element and a second reflector element overlying the second heating element.

In the following description, there are shown and described several preferred embodiments of the convertible top. As it should be realized, the convertible top is capable of other, different embodiments and their several details are capable of modification in various, obvious aspects all without departing from the convertible top as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the heat generating system and related methods and together with the description serve to explain certain principles thereof.

FIG. 1 is a schematic block diagram of the heat generating system.

FIG. 1a is a schematic block diagram of one possible embodiment of a controller for the heat generating system.

FIG. 2 is an illustration of one possible embodiment of the heat generating system wherein a heating element of that system is utilized to heat the ground adjacent a door of the motor vehicle in order to melt ice and snow and improve the footing for individuals seeking to enter the motor vehicle.

FIG. 3 is an illustration of yet another possible embodiment of the heat generating system wherein the heating element is provided on a dashboard to heat the windshield of the motor vehicle.

FIG. 4 is an illustration of still another possible embodiment of the heat generating system wherein the heating element of the heat generating system is provided along an interior surface of the roof of the motor vehicle in order to heat the passenger compartment of the motor vehicle including the seat backs and seat faces as well as any individuals that may be sitting in the motor vehicle.

FIGS. 5a-5c are various schematic illustrations of a convertible top incorporating a heating element between an outer layer and a liner.

FIG. 5a is a bottom plan view of the convertible top oriented in a generally flat configuration.

FIG. 5b is a cross sectional view through a segment of the convertible top illustrated in FIG. 5a.

FIG. 5c is a schematic block diagram of the heat generating system of the convertible top of FIGS. 5a and 5b.

Reference will now be made in detail to the present preferred embodiments of the convertible top, examples of which are illustrated in the accompanying drawing figures.

### DETAILED DESCRIPTION

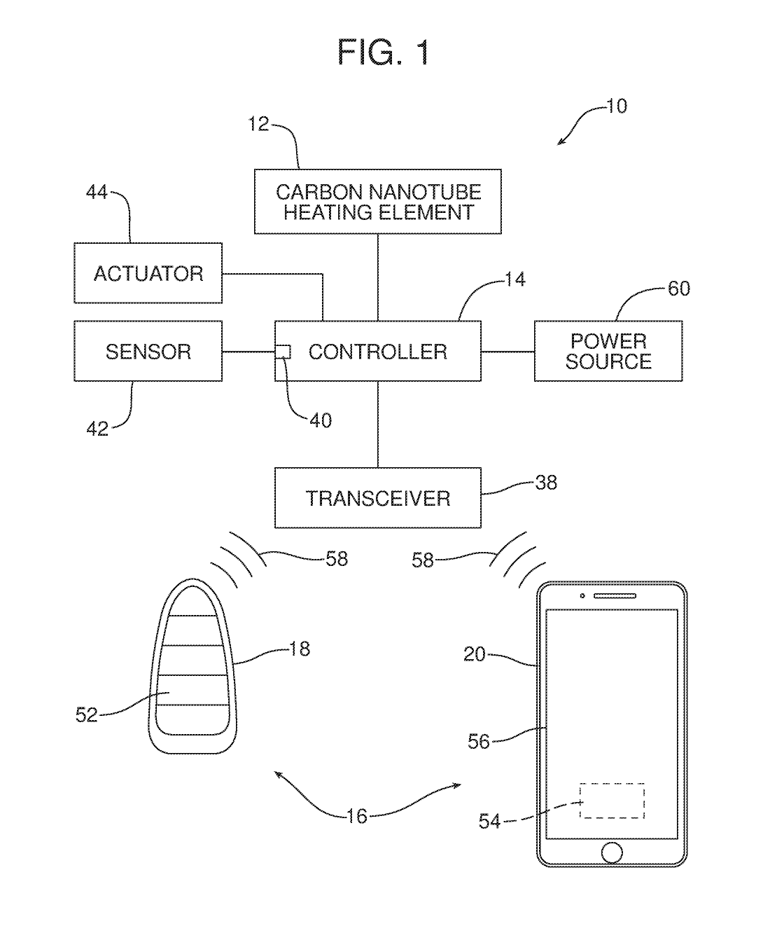

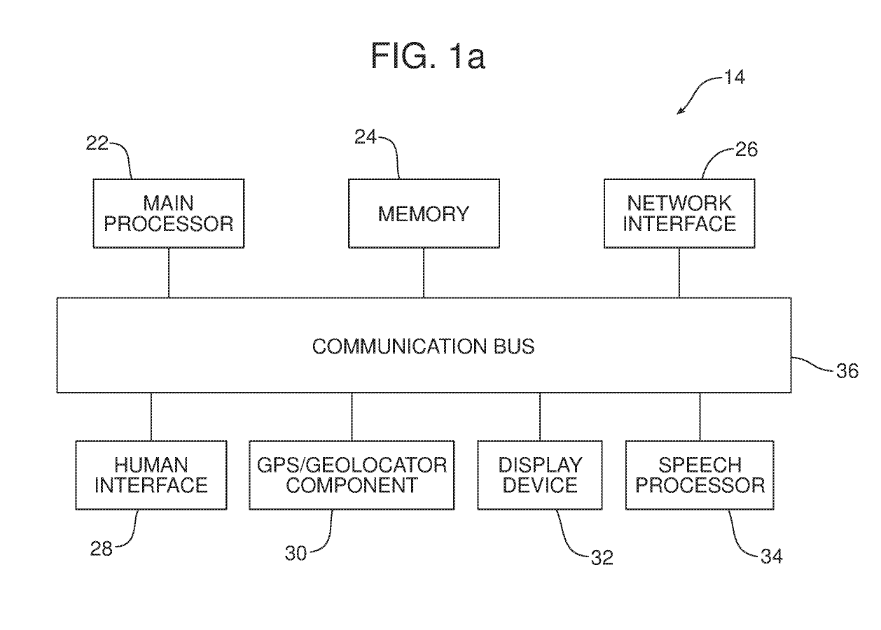

Reference is now made to FIG. 1 which schematically illustrates the new and improved heat generating system 10. That heat generating system 10 includes a heating element 12 such as a carbon nanotube heating element of a type known in the art. Such a heating element 12 may take a number of forms including a carbon nanotube sheet or a carbon nanotube coating provided on an appropriate substrate.

As further illustrated in FIG. 1, the heat generating system 10 includes a controller 14. The controller 14 is configured to activate the heating element 12 in response to a wireless activation signal received from a remote communication device 16 such as the key fob 18 or the cell phone 20.

More specifically, the controller 14 may comprise a computing device such as a dedicated microprocessor or electronic control unit (ECU) operating in accordance with instructions from appropriate control software. As illustrated in FIG. 1a, the controller 14 comprises a body control module (BCM) including one or more processors 22, one or more memories 24, one or more network interfaces 26, a human interface 28, a GPS/geolocator component 30, a display device such as a multi-function display with touchscreen capability 32, and a speech processor 34, having voice command capability, that all communicate with each other over a communication bus 36. Such a BCM controller 14 may perform a number of interior body electrically based functions including, for example, interior locking, remote key entry, interior lighting, exterior lighting, windshield wiper control and the like. In some embodiments a BCM controller 14 of this type may also function to control entertainment functions (e.g. radio, CD player) and communications such as telephone and internet communications over a wireless network. In some embodiments a BCM controller 14 is connected by a communication bus (not shown) to other control modules that provide one or more of these additional functions.

As illustrated in FIG. 1, the controller 14 is connected to a transceiver 38 adapted for wireless communication with the remote communication device 16 such as the key fob 18 and cell phone 20. As should be appreciated and as is known in the art, such a key fob 18 includes built-in authentication to allow authorized access and communication with the controller 14 of a matched motor vehicle. Such a cell phone 20 may run an app providing a similar built-in authentication for the same purpose.

As further illustrated in FIG. 1, the controller 14 may include a data input 40 connected to an appropriate sensor 42 such as a heating element temperature sensor, an ambient temperature sensor or any other appropriate sensor or monitoring device capable of providing data of interest to the controller for operating the heating element 12.

As also illustrated in FIG. 1, the controller 14 may be connected to and configured to control an actuator 44 capable of displacing the heating element 12 between a stowed position and a deployed position in a manner that will be described in greater detail below. Such an actuator 44 may comprise a hydraulic actuator, a pneumatic actuator, a mechanically driven linkage or any other type of actuator capable of displacing the heating element 12 in the desired manner.

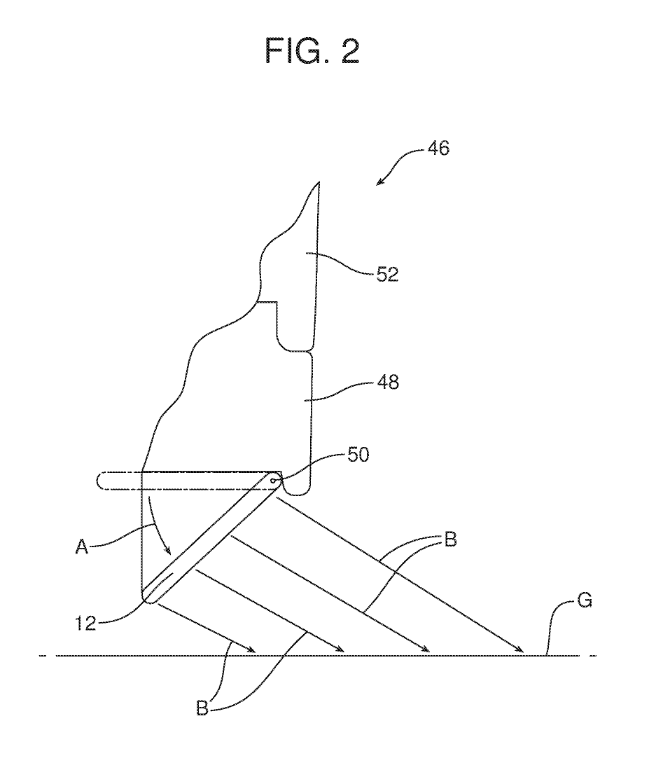

In the embodiment illustrated in FIG. 2, the heating element 12 is carried on the motor vehicle 46 adjacent a rocker panel 48. In the illustrated embodiment, the heating element 12 is connected by means of a hinge 50 to the frame or rocker panel 48 of the motor vehicle 46. The actuator 44 (see also FIG. 1) pivots (note action arrow A) the heating element 12 between a stowed position (illustrated in phantom line), wherein the heating element is folded up under the rocker panel 48 in a protected position, and a deployed position (illustrated in full line) wherein the heating element is oriented to direct IR-radiation upon an area of the ground G adjacent a door 52 of the motor vehicle in order to melt ice and snow. Note action arrows B illustrating the path of the generated IR-radiation.

Thus, an operator of the motor vehicle 46 may depress, for example, a dedicated button 53 on a key fob 18 or display screen button 54 on the display screen 56 of the cell phone 20 in order to send a wireless activation signal 58 that is received by the transceiver 38 and directed to the controller 14. Following authentication, the controller 14 responds to the wireless activation signal 58 received from the remote communication device 16 by routing power from the power source 60 of the motor vehicle to activate the heating element 12 and melt ice and snow on the ground G adjacent the door 52 of the motor vehicle. This provides the operator of the motor vehicle 46 with better footing when reaching the motor vehicle 46 and opening the door 52.

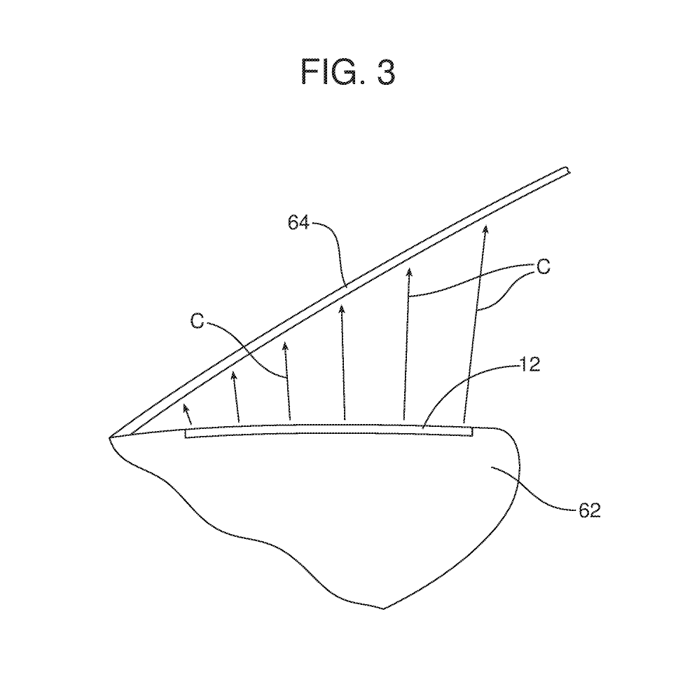

As illustrated in FIG. 3, the heating element 12 is provided in the upper surface of the dashboard 62. In such an embodiment, when a wireless activation signal is received from the remote communication device 16, the controller 14 activates the heating element 12 which is oriented to direct IR-radiation upon an area of the windshield 64 (note action arrow C) to heat that area of the windshield, defogging the windshield and/or melting ice and snow.

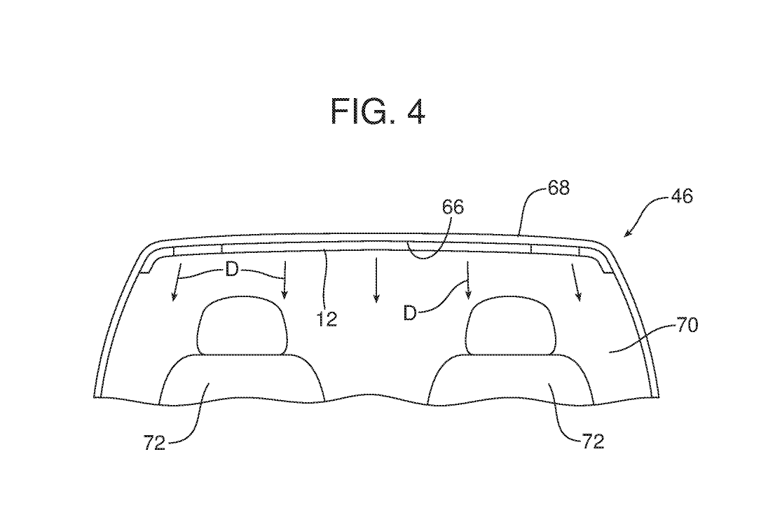

As illustrated in FIG. 4, the heating element 12 is mounted to the underside 66 of the roof 68 of the motor vehicle 46. In this embodiment, the controller 14 is configured to activate the heating element 12 in response to the wireless activation signal received from the remote communication device 16. When activated, the heating element directs IR-radiation downward into the passenger compartment 70 of the motor vehicle (note action arrows D) toward the seats 72 and any individuals sitting therein. IR-radiation from above provides a unique warming effect greatly enhancing the comfort of any individual sitting in the seats 72 in cold weather conditions.

Consistent with the above description, a method is provided of heating a passenger compartment 70 of a motor vehicle 46. That method comprises locating a heating element 12 on an underside 66 of the roof 68 of the motor vehicle and directing heat, in the form of IR-radiation, from the heating element downward into the passenger compartment.

Toward that end, the method may include using a carbon nanotube heating element 12 for generating IR-radiation and controlling operation of the heating element by means of a controller 14. Further, the method may include configuring that controller 14 to activate the heating element 12 in response to a wireless activation signal 58 received from a remote communication device 16 such as the key fob 18 or cell phone 20.

The method may also include locating a second heating element 12 on a dashboard 62 and directing heat from that second heating element upward onto the windshield 64 of the motor vehicle 46. In such an embodiment the method may include configuring the controller 14 to activate the second heating element 12 on the dashboard 62 in response to a second activation signal 58 from the remote communication device 16.

Still further, the method may include locating a third heating element 12 adjacent a rocker panel 48 and directing heat from that third heating element upon an area of the ground G adjacent a door 52 of the motor vehicle 46 in order to melt ice and snow. In such an embodiment, the method may include configuring the controller 14 to activate the third heating element 12 adjacent the rocker panel 48 in response to a third activation signal 58 received from the remote communication device 16. Here again it should be noted that the method may include using a key fob 18 with built in authentication or a cell phone 20 paired by an app to the motor vehicle 46 as the remote communication device 16.

In accordance with still another aspect, the method may comprise a method of heating an area of the ground G adjacent a door 52 of the motor vehicle 46. Such a method comprises locating a heating element 12 adjacent a rocker panel 48 of the motor vehicle 46 and directing heat from the heating element upon the area of the ground G adjacent the door 52 in order to melt the ice and snow.

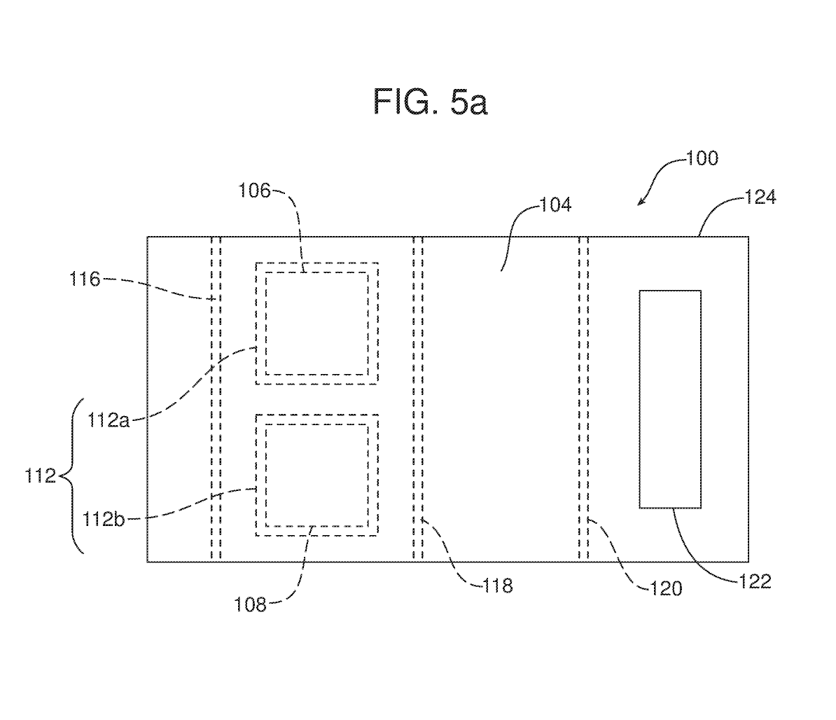

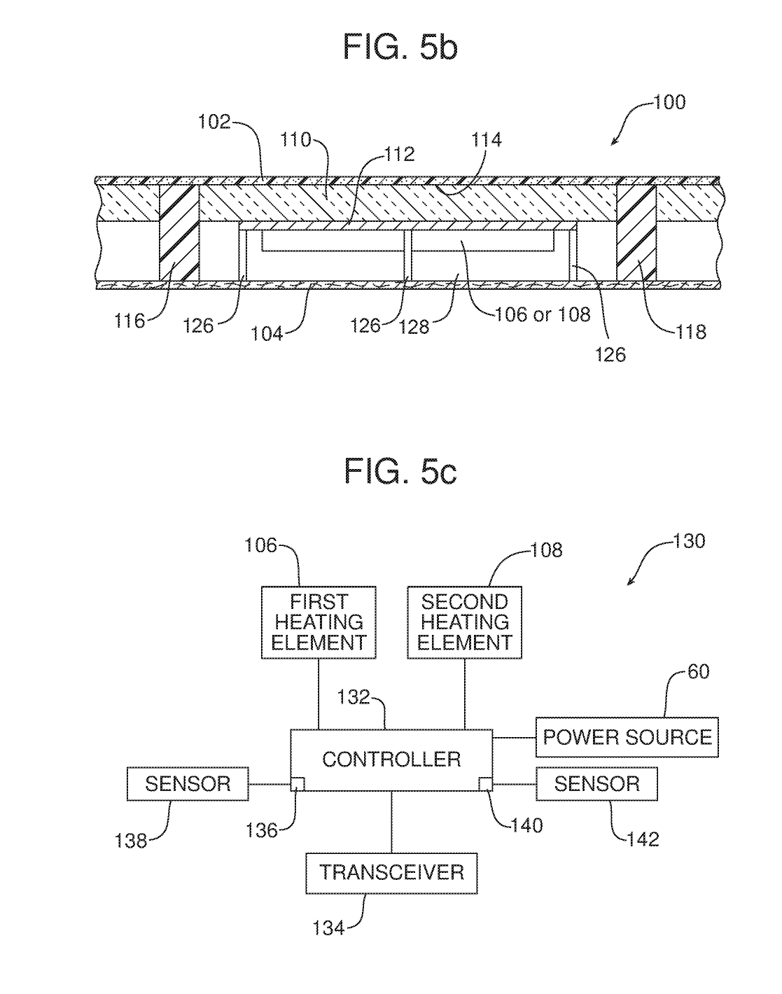

Reference is now made to FIGS. 5a-5c illustrating a soft convertible top 100 including an outer layer 102 made from a flexible waterproof material of a type well known in the art, a liner 104, made from a liner material of a type known in the art, and a heating element provided between the outer layer 102 and the liner 104. More specifically, in the illustrated embodiment, the heating element comprises a first carbon nanotube heating element 106 and a second carbon nanotube heating element 108. As best illustrated in FIG. 5b, the convertible top 100 may also include an insulation layer 110 and a heat reflector 112 between the outer layer 102 and the first and second heating elements 106, 108. More specifically, the insulation layer 110 may be provided along the inner face 114 of the outer layer 102 and the reflector 112 may be provided between the insulation layer 110 and the first or second heating element 106, 108.

The insulation layer 110 may be made from any thermal and sound insulating material known in the art to be suitable for the intended purpose of insulating a soft convertible top 100. In the illustrated embodiment, the reflector 112, also made from known heat reflecting material, may comprise a first reflector element 112a overlying the first heating element 106 and a second reflector element 112b overlying the second heating element 108.

As further illustrated in FIGS. 5a and 5b, the convertible top 100 may include a first rib 116, a second rib 118 and a third rib 120 between the outer layer 102 and the liner 104. In the illustrated embodiment, the first heating element 106 and the second heating element 108 are positioned between the first rib 116 and the second rib 118. In addition, the convertible top 100 includes a window 122 in the rear section 124 aft of the third rib 120. When convertible top 100 is closed, it should be appreciated that the first heating element 106 is positioned above the driver's seat and the driver of the motor vehicle while the second heating element 108 is positioned above the front passenger and the front passenger seat of the motor vehicle.

A stand off 126 may be provided between the reflector 112 and the liner 104. In the illustrated embodiment, the stand off 126 extends around the periphery of the heating element 106, 108 in order to maintain a free space 128 between the heating element and the liner 104.

Reference is now made to FIG. 5c illustrating the heat generating system 130 of the convertible top 100. The heat generating system 130 includes the first heating element 106, the second heating element 108 and the controller 132. The controller 132 is configured to provide independent control of the first heating element 106 and the second heating element 108. In addition, the controller 132 is configured to activate the first heating element 106, the second heating element 108 or both the first heating element and the second heating element in response to an activation signal received from a remote communication device.

The controller 132 may comprise a computing device such as a dedicated microprocessor or electronic control unit (ECU) operating in accordance with the instructions from appropriate control software. The controller 132 may comprise a body control module (BCM) such as described above and illustrated in FIG. 1a. In some embodiments, the controller 132 may comprise two or more computing devices.

As illustrated in FIG. 5c, the controller 132 is connected to a transceiver 134 adapted for wireless communication with a remote communication device 16, such as a key FOB 18 and a cell phone 20 as illustrated in FIG. 1. As should be appreciated and as is known in the art, such a key FOB 18 includes built-in authentication to allow authorized access and communication with the controller of a matched motor vehicle. Such a cell phone 20 may run an app providing a similar built-in authentication for the same purpose.

As further illustrated in FIG. 5a, the controller 132 may include a data input 136 connected to a sensor 138, such as a heating element temperature sensor, an ambient temperature sensor or any other appropriate sensor or monitoring device capable of providing data of interest to the controller for operating the heating element 106. Similarly, the controller 132 may include a data input 140 connected to a sensor 142, such as a heating element temperature sensor, an ambient temperature sensor or any other appropriate sensor or monitoring device capable of providing data of interest to the controller for operating the second heating element 108.

In use, an operator may activate either the first heating element 106, the second heating element 108 or both heating element 106, 108 via human interface or switch (not shown) operatively connected to the controller 132. For example, the controller 132 may be connected to a touchscreen allowing an operator to activate either heating element 106, 108 as well as the possibility of setting a desired temperature for the heating element. Alternatively, a dedicated button 53 on a key FOB 18 or display screen button 54 on a display screen 56 of a cell phone 20 may be depressed in order to send a wireless activation signal that is received by the transceiver 134 and directed to the controller 132. Following authentication, the controller 132 responds to the wireless activation signal received from the remote communication device 16 by routing power from the power source 60 of the motor vehicle to activate the first heating element 106, the second heating element 108 or both heating elements as desired by the operator and begin heating the interior or passenger compartment of the motor vehicle above the driver and/or front passenger seat. Advantageously, the heating element 106, 108 in the convertible top 100 provide a very welcomed heat sensation to the head, face and chest of the driver and passenger seat occupants on a cold winter day making use of a soft top convertible more practical on a cold winter day. Significantly, heated seats cannot deliver this warming effect.

Numerous benefits and advantages are provided by the heat generating system 10. The heat generating system 10 is particularly useful when used in conjunction with the remote start feature for a motor vehicle 46 allowing (a) the melting of ice and snow from the windshield 64 so as to provide clear visibility and allow one to drive immediately upon entering the vehicle or (b) the melting of ice and snow on the ground G adjacent the door 52 of the motor vehicle so as to allow one to have better footing and easier access to the motor vehicle when reaching the door. Further, the heat generating system 10 may allow one to preheat the passenger compartment 70 of the motor vehicle before entering the motor vehicle. This increases operator comfort. In addition, the overhead heating element 12 and the convertible top heating elements 106, 108 provide a warm radiant heat from above that is particularly comfortable and makes an individual feel warmer on a cold winter day and particularly as the passenger compartment is first being warmed.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A convertible top, comprising:
an outer layer;
a liner; and
a heating element between said outer layer and said liner.

2. The convertible top of claim 1, wherein said heating element is a carbon nanotube heating element.

3. The convertible top of claim 2, further including a controller configured to activate said heating element in response to a wireless activation signal received from a remote communication device.

4. The convertible top of claim 3, further including an insulation layer between said outer layer and said heating element.

5. The convertible top of claim 3, further including a reflector between said outer layer and said heating element.

6. The convertible top of claim 3, further including an insulation layer and a reflector between said outer layer and said heating element.

7. The convertible top of claim 6, wherein said reflector is adjacent said heating element and said insulation layer is between said reflector and said outer layer.

8. The convertible top of claim 7, further including a first rib and a second rib between said outer layer and said liner, said heating element being positioned between said first rib and said second rib.

9. The convertible top of claim 8, further including a window.

10. A convertible top, comprising:
an outer layer;
a liner;
a first heating element between said outer layer and said liner; and
a second heating element between said outer layer and said liner.

11. The convertible top of claim 10, including a controller configured to provide independent control of said first heating element and said second heating element.

12. The convertible top of claim 11, wherein said controller is further configured to activate said first heating element, said second heating element or both said first heating element and said second heating element in response to an activation signal received from a remote communication device.

13. The convertible top of claim 12, wherein said first heating element and said second heating element are carbon nanotube heating element.

14. The convertible top of claim 13, further including an insulation layer between (a) said outer layer and (b) said first heating element and said second heating element.

15. The convertible top of claim 13, further including a reflector between (a) said outer layer and (b) said first heating element and said second heating element.

16. The convertible top of claim 13, further including an insulation layer and a reflector between (a) said outer layer and (b) said first heating element and said second heating element.

17. The convertible top of claim 16, wherein said reflector is adjacent (a) said first heating element and said second heating element and (b) said insulation layer is between said reflector and said outer layer.

18. The convertible top of claim 17, further including a first rib and a second rib between said outer layer and said liner, said first heating element and said second heating element being positioned between said first rib and said second rib.

19. The convertible top of claim 18, further including a window.

20. The convertible top of claim 19, wherein said reflector includes a first reflector element overlying said first heating element and a second reflector element overlying said second heating element.
